(19) United States
(12) Patent Application Publication
(10) Pub. No.: US 2002/0120939 A1
(43) Pub. Date: Aug. 29, 2002

(54) Webcasting system and method

(76) Inventors: Jerry Wall, Edmond, OK (US); Paul A. Carter, Edmond, OK (US); Brandon N. Burk, Oklahoma City, OK (US); Jens A. Serna, Oklahoma City, OK (US); Yoshio Y. Kurtz, San Diego, CA (US); Paul L. Emmons, Edmond, OK (US); Timothy L. Cloud, Edmond, OK (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/741,365

(22) Filed: Dec. 18, 2000

(51) Int. Cl. H04N 7/173; H04N 5/445

(52) U.S. Cl. 725/87; 725/110; 725/37; 725/1

(57) ABSTRACT

A webcasting system and method for presenting multimedia content to viewers over the internet. The user (creator) of the webcast presentation is able to create and send the webcast to viewers using a simple, web-based process. The webcast includes a video presentation and slide presentation. Video and slide presentation files are automatically encoded and uploaded to a media server, without the user needing to understand file formats of the webcast content or how the files are to be compressed for efficient storage and transmission. The synchronization and editing of the video and slide presentations is made efficient by separately storing or buffering the slide file at the viewer's system before the video is streamed to the viewer's system. Slide files prepared in a structured storage format (PowerPoint) are automatically converted to JPG format in order to more efficiently transmit the presentation to the viewer.

### BACKGROUND OF THE INVENTION

Webcasting has become one of the most powerful ways of delivering information over the internet. By creating a webcast presentation or program, a user can simultaneously present information to viewers in several different mediums, such as video, graphics, slides and text. The transmission of the presentation can be at an announced time and viewed simultaneously by a large number of individuals, or can be made accessible (e.g., through a website) so that an individual can view the webcast at a time that is most convenient. For example, in a business sales environment, a salesperson can deliver a presentation to a prospective customer when it is most convenient for the customer to view it. The presentation can include a video of the salesperson, as well as a graphical display of the product and text information. As another example, a senior manager in a large company may deliver a speech across the company to all employees. The speech may be viewed in real time by those employees who are able to see it immediately, or at any time after that by other employees who were not able to see it immediately.

There are several aspects of webcasting that have limited its potential use. One aspect that has been the resources required for producing the content. Webcasting has been more commonly used by large organizations that either have internal staff for producing the content or can afford the cost of hiring a production company to produce the content. In the past, sophisticated equipment was often required, for example, to record a video presentation, and skilled production staff was needed to edit the video recording and then to develop graphics and slides and put all the material in the proper order. Without skilled staff and sophisticated equipment, the webcast did not have a “professional” look. A small business or a consumer, as a result, often has used a medium other than webcasting to deliver information. Even with the recent drop in the cost of video cameras and systems, the lack of video production skills has continued to make it impractical for many businesses and most consumers to use webcasting.

Another aspect that has limited the potential use of webcasting is the technical complexity involved in encoding and uploading content to the webcasting server. The manner in which it is encoded will depend in part on the format in which it has been recorded and stored, and thus the person developing the webcast has needed to understand the file format of each component of the presentation (video, graphics, text, slides) and make sure that it gets appropriately encoded as well as synchronized for proper ordering in the final webcast presentation. A small business or a consumer who has desired to produce a webcast often does not have these technical skills.

### SUMMARY OF THE INVENTION

Embodiments of the present invention are directed to a system and method for creating and transmitting webcast programs. In accordance with one embodiment of the invention, a network is provided for transmitting a multimedia (webcast) program from a user (a webcast creator or producer) to one or more program recipients (viewers). The network includes a server system and a recipient system and the multimedia program includes a first media program (a slide presentation or program) and a second media program (a video presentation or program). The first media program has plural program components (slide views) that are synchronized with the second media program so that each component appears at predetermined times during the second media program. A method for transmitting the multimedia program to each recipient includes storing the first and second media programs at the server system, transmitting the first media program and the second media program to the recipient system, and synchronizing the first media program components with the second media program after the first media program has been received at the recipient system. The multimedia program may further include a chat presentation and a live discussion session, as well as a feature for providing written transcripts of the webcast program to recipients In another embodiment of the invention, there is provided a method and system for encoding at least one of the media programs before being transmitted to the server system, and for automatically encoding the media program based on its file format. File format is determined from the header (name field) of the stored media program at the producer system.

In still another embodiment of the invention, the slide presentation of the multimedia program is stored at the producer system (user) as a structured data file (e.g., PowerPoint). That file is converted into an image-based format (e.g., JPG) automatically, by invoking JPG object modules associated with the PowerPoint file.

Reference to remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

In the Figures, similar components and/or features may have the same or similar reference number or label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a schematic diagram of a webcast network in accordance with the present invention.

FIG. 2 is a simplified flow diagram illustrating the general operation of the webcast network of FIG. 1.

FIG. 3 is a detailed flow diagram of the overall operation of the webcast network.

FIG. 4 is a detailed block diagram illustrating the functional components of the webcast network and the interconnection of those components.

FIGS. 5(a) through 5(c) are examples of screens or views in a webcast presentation, illustrating the general appearance of the presentation, the prompting of a voice discussion session during the presentation, and the prompting of a “pay-per-view” charge.

FIGS. 6(a) through 6(l) are examples of pages seen by the user in creating a webcast presentation.

FIG. 7 is a flow diagram illustrating the conversion and encoding of video files for transmission to the web server.

FIG. 8 is a flow diagram illustrating the automatic conversion of a slide presentation from a PowerPoint file to a JPG file in order to synchronize slides with a video component of the webcast presentation.

FIG. 9 is a flow diagram illustrating the downloading of a slide presentation and a video (media) presentation, and the synchronization of those files at the viewer system.

FIG. 10 is a table illustrating exemplary timing data for synchronizing the slide presentation to the video presentation.

FIG. 11 illustrates the file format of an .avi video file.

### DESCRIPTION OF THE SPECIFIC EMBODIMENTS

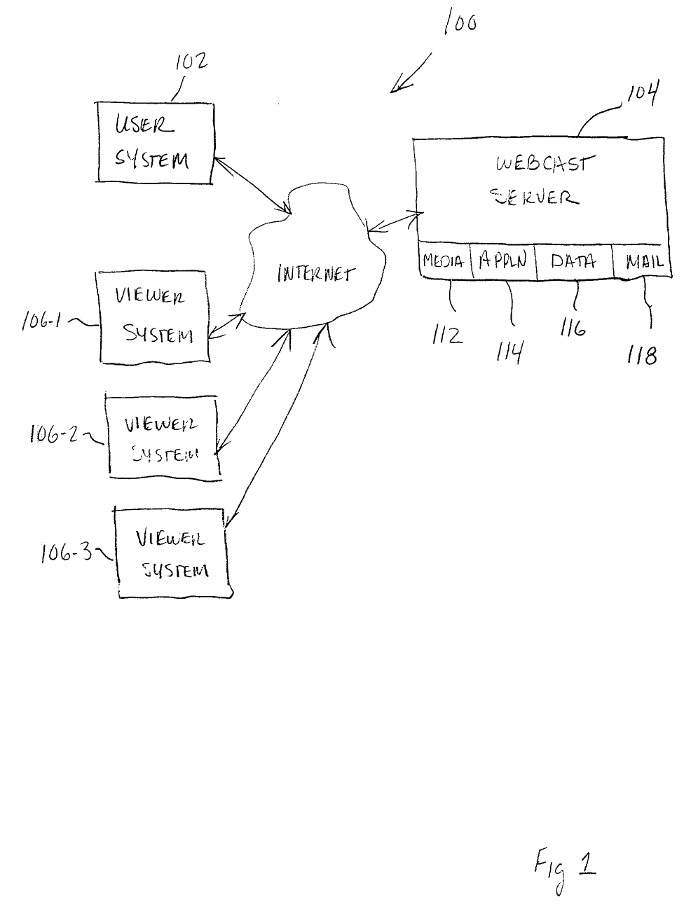

Referring now to FIG. 1, there is shown a webcasting network 100 that includes a user system 102, a webcast server system 104 and a plurality of viewer systems 106-1, 106-2 and 106-3. As illustrated, the systems 102, 104 and 106-1 through 106-3 are interconnected through the internet. However, it should be understood that other forms of network interconnection could be used within the scope of the invention, such as an intranet or a local area network.

The user system 102 is used by the person desiring to create or produce a webcast program, with the webcast consisting of any one or more of various forms of multimedia presentations, such as video, slides, “chat”, text, or audio. The server system 102 has several servers or server subsystems 112, 114, 116 and 118. The server subsystem 112 represents one or more media servers (including storage devices) that store the webcast content or presentation after it has been created. The application server 114 stores application programming for controlling the creation of the webcast presentation and the overall operation of the webcast server. The server 114 is accessed as an internet website by the user system 102, and by downloading html documents (web pages) and applets to the user system 102, the application server 114 enables the user to create webcasting programs in a manner to be more fully described later.

The data server 116 stores data that is used by the server system 104 in creating and broadcasting webcasts and handling administrative functions performed by the system 104. This includes storing text data used in the webcast, billing data relating to users or viewers, and usage information (e.g., identifying viewers of webcasts) and the like. The mail server 118 implements email functions used in creating and transmitting certain webcast programs, such as notifications to viewers when a webcast presentation is available for viewing.

The viewer systems 106-1, 106-2 and 106-3 may be personal computers, desktop systems, personal digital assistants (PDAs) or other devices connected (either by wireline or wireless) to the internet for viewing webcast presentations. Preferably, each viewer system 106 has both a display device and a speaker (audio) device. While only three such systems are shown, it should be appreciated that the number of viewers could be only a few, or could be a thousand or more, depending on the number of viewers that the producer of the webcast desires to have view his or her webcast presentation. As should be apparent, any person with access to the internet is a potential viewer of the presentation.

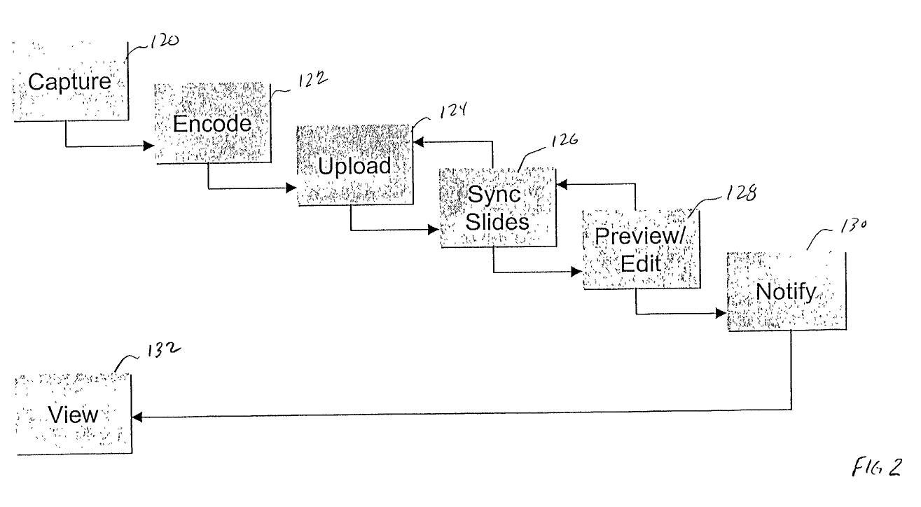

The general operation of the webcasting network 100 of FIG. 1 will now be described with reference to the flow diagram in FIG. 2. For present purposes, the operation described has been simplified and assumes that the webcast presentation will have only two forms of media: (1) a video presentation (with accompanying audio) and (2) a slide presentation to be synchronized with the video presentation. However, as should be apparent (and as will be described in greater detail later), the general operation will be applicable to additional forms of media, such as audio (only), text, chat and live voice communication. Also, in accordance with the present invention, the user or webcast producer at the user system 102 is led through the steps of FIG. 2 without the need for technical training in the production of webcasts. More specifically, the process is implemented by accessing a website maintained at the webcast server 104, and following a simple and straightforward procedure in response to prompts on pages displayed at the user system.

At the first step 120, the producer of the webcast program captures the content, i.e., the video and the slide presentations. If, for example, the webcast is a sales presentation to potential customers, a digital video camera could be used to record and store in the user system 102 the “live” video presentation of a sales person (the “presenter”). The video presentation could be stored in the system 102 as a video file, e.g., in an avi, .mov or MPEG format. In addition to the video, the presenter would have a slide presentation (multiple slide views) emphasizing important points being made and, in a sales presentation, highlighting features of the product or service being presented to the potential customers. At the next step 122, the video and slide presentations are encoded (compressed) so that they can be uploaded (step 124) to the media server 112, and then later downloaded and streamed as needed. It is an important feature of the present invention that the user does not need to concern himself with the details of the encoding or the uploading. Rather, a “drag and drop” (or similar) feature, to be described in greater detail later, prompts the user to individually select video and slide files, and then automatically initiates the encoding and uploading. An application downloaded to the user system 102 checks the format of each of the files that are selected and encodes the bit stream for the appropriate server. For example, video files can be converted from avi, .mov or MPEG formats to a standard .asf format, if the media server is a Microsoft media server. Slide presentation files can be automatically converted (to be described in greater detail later) from PowerPoint format to a JPG format.

After the video and slide presentations are uploaded, they are then presented back to the user in a graphical display that permits the user to synchronize the slides with the video (step 126). The user then previews and edits the webcast as necessary (e.g., adjusting the synchronization of the slide presentation), step 128.

The webcast presentation is then complete, stored (uploaded) in the media server 1 12, and ready for transmission to an audience of viewers. The user can use the mail server 118 to send emails messages to notify each desired or potential viewer (step 130). The email message could include an html link for the viewer to access the webcast server 104, so that the webcast presentation is transmitted to each requesting viewer system 106-1 through 106-3 (step 132). One feature of the present invention is that the storing of the presentation and subsequent downloading and streaming to the viewer is done in a way that permits convenient modification to the webcast, even after it has been initially produced and transmitted to viewers. As will be more fully illustrated later, the video and slide presentation files are stored separately at the media server 112, and during the webcast transmission, the slide file is first downloaded to the viewer. The video file is then subsequently streamed to the same viewer. In accordance with this aspect of the present invention, if the webcast producer desires to update or correct a single slide, the change can be made to only the slide needing the change, without having to recreate the webcast. The changed slide is simply substituted for the original slide in the media server 112, and then downloaded to the viewer systems 106-1 through 106-3 with the rest of the slides and put into the appropriate place in the video presentation when the video is streamed to the viewer.

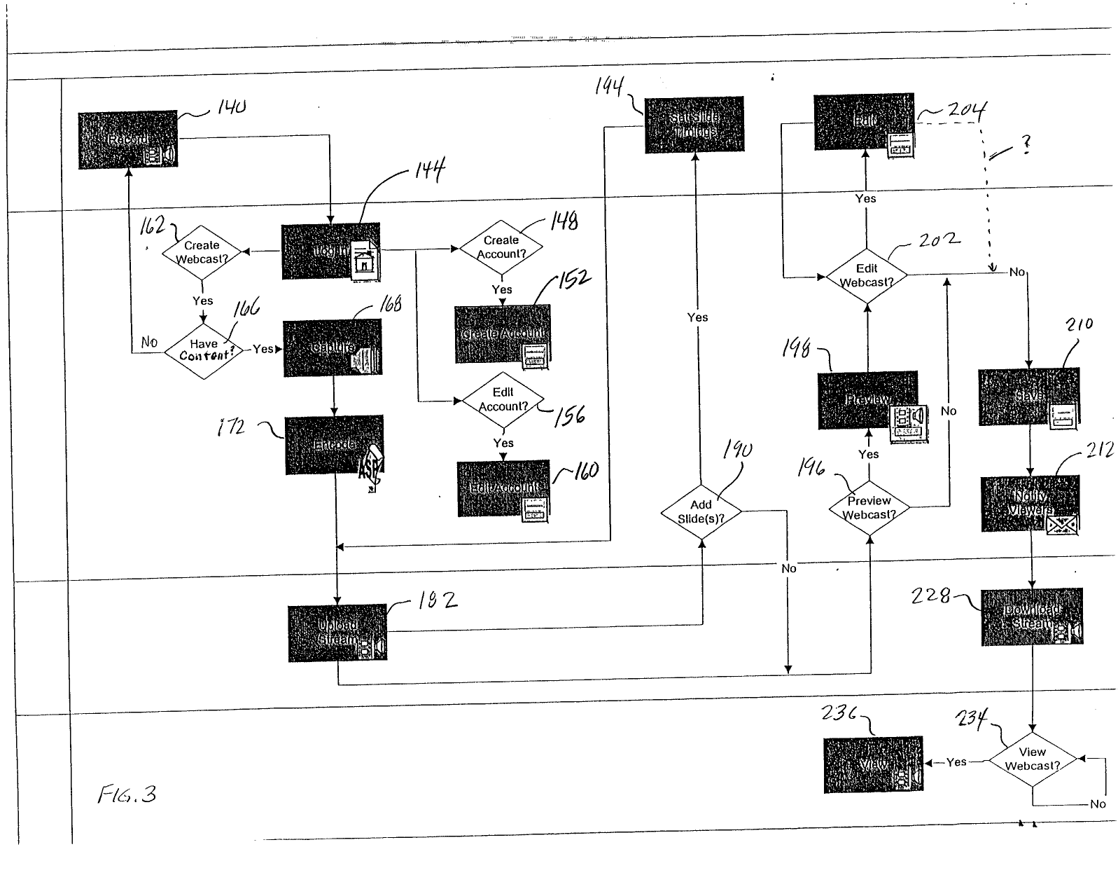

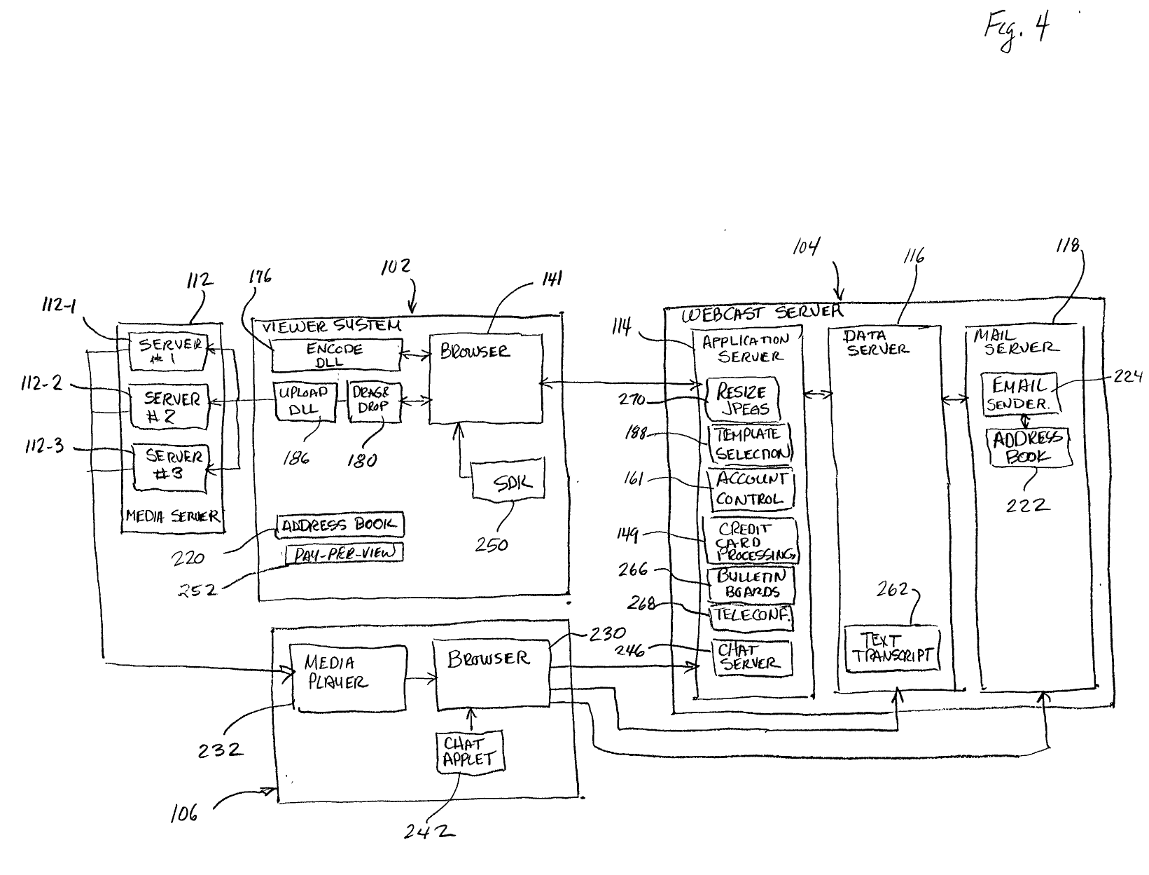

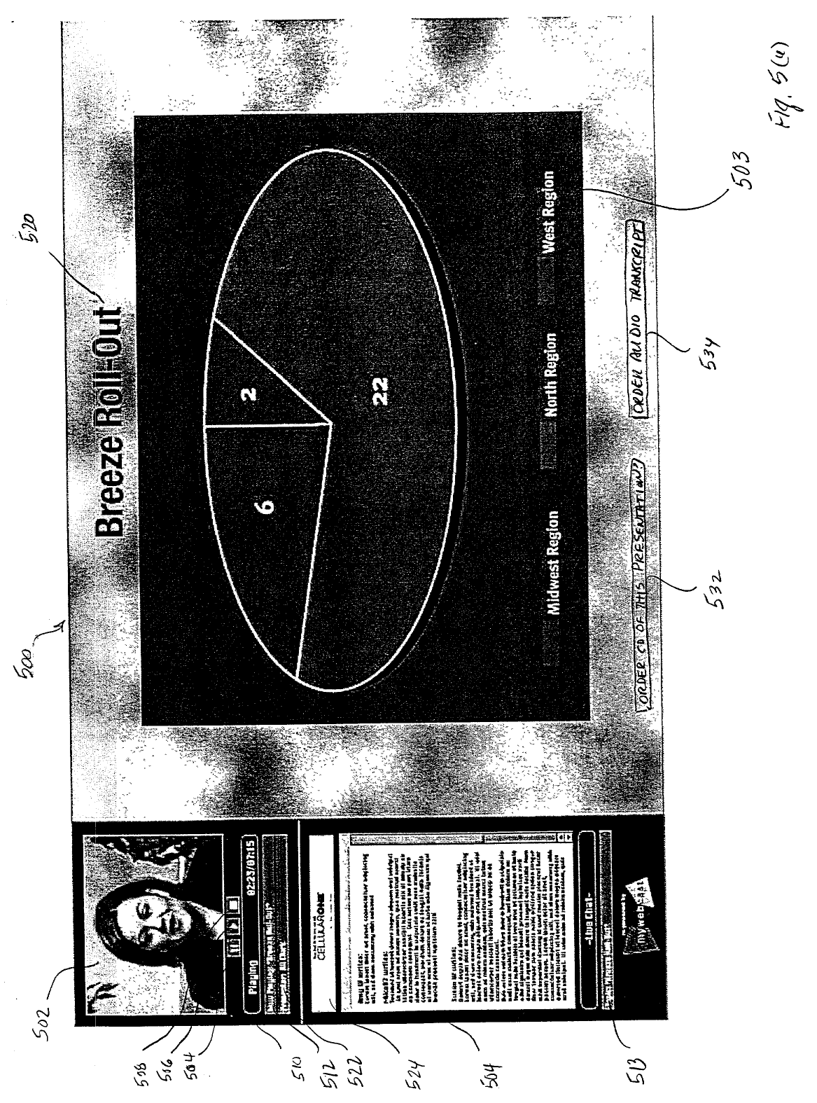

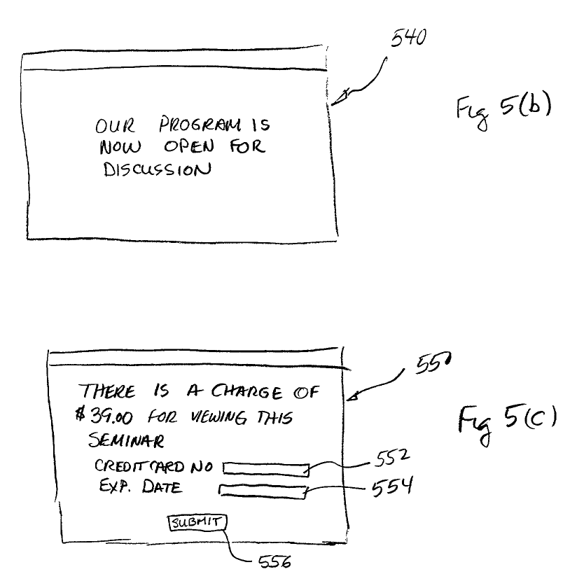

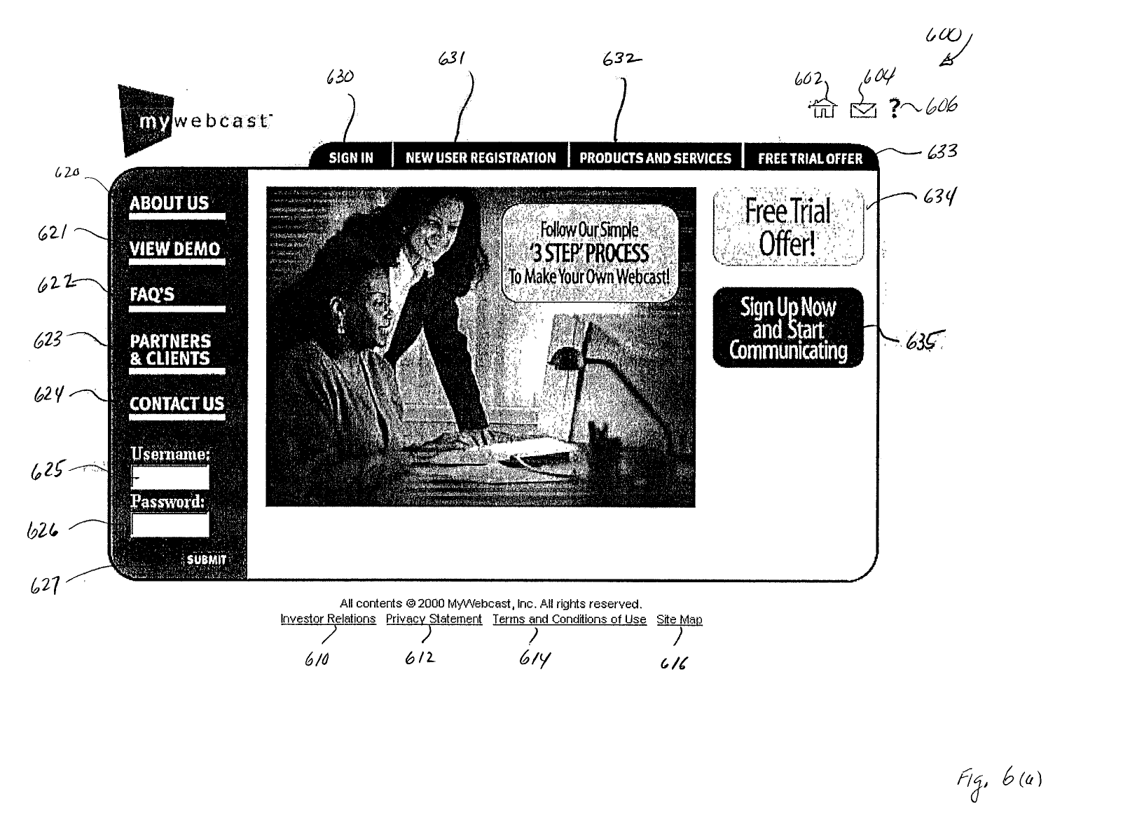

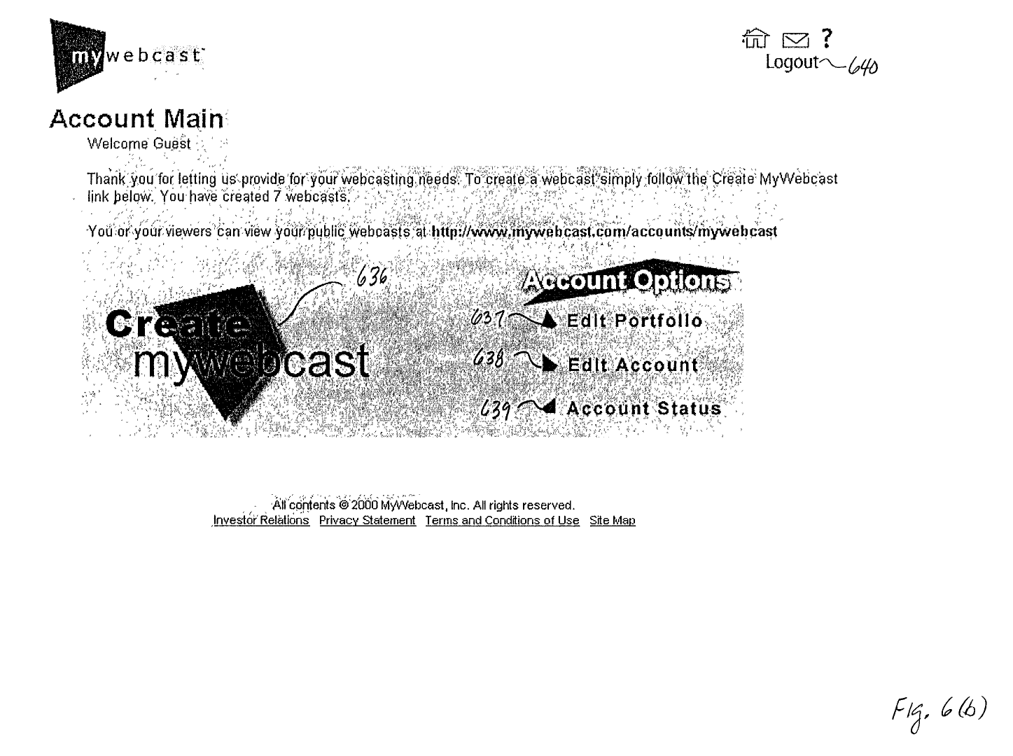

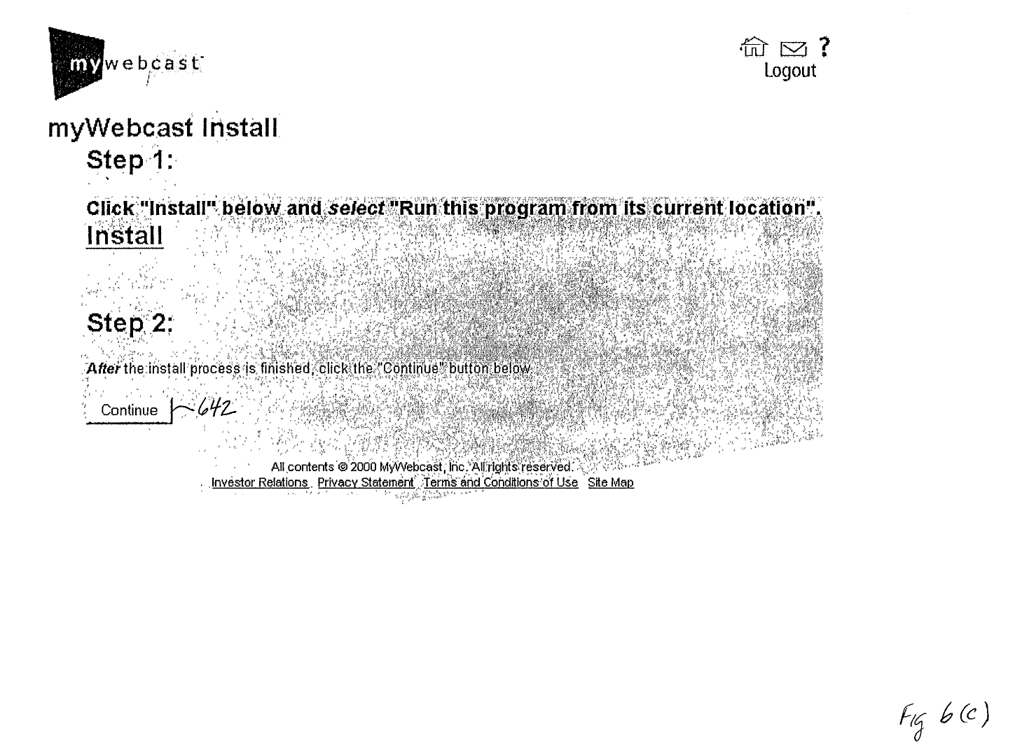

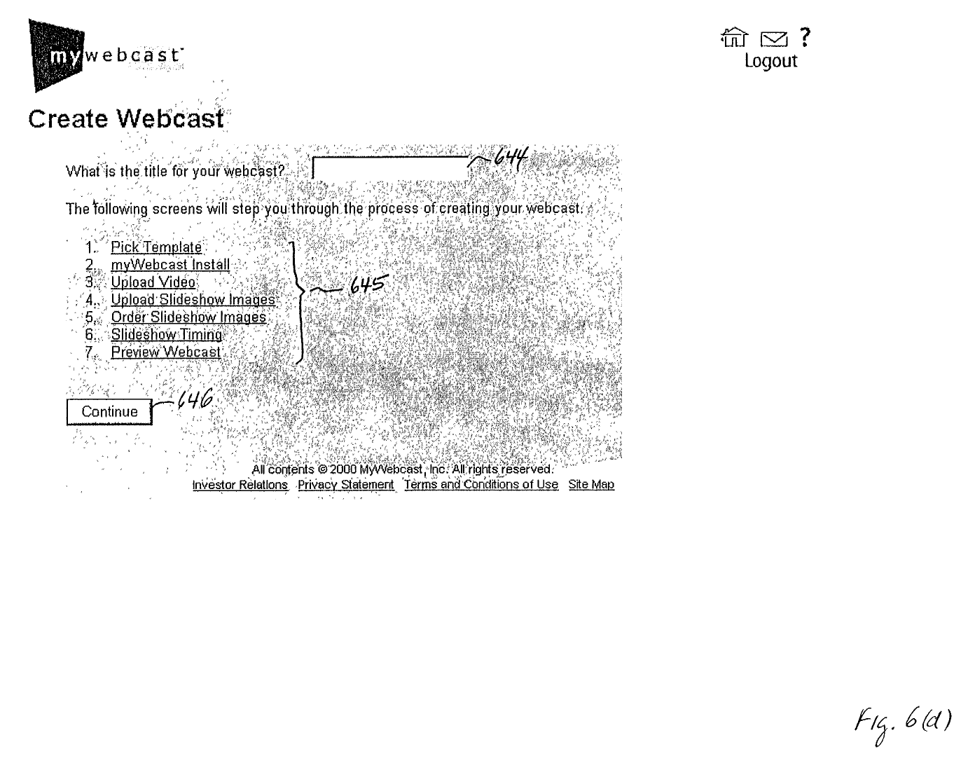

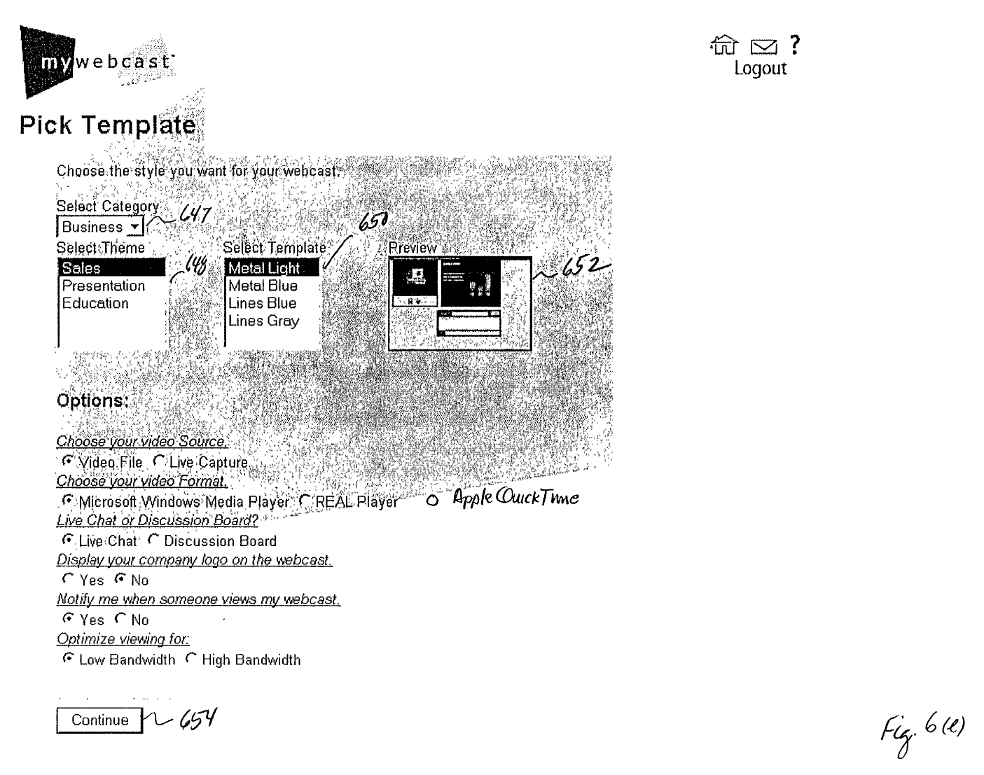

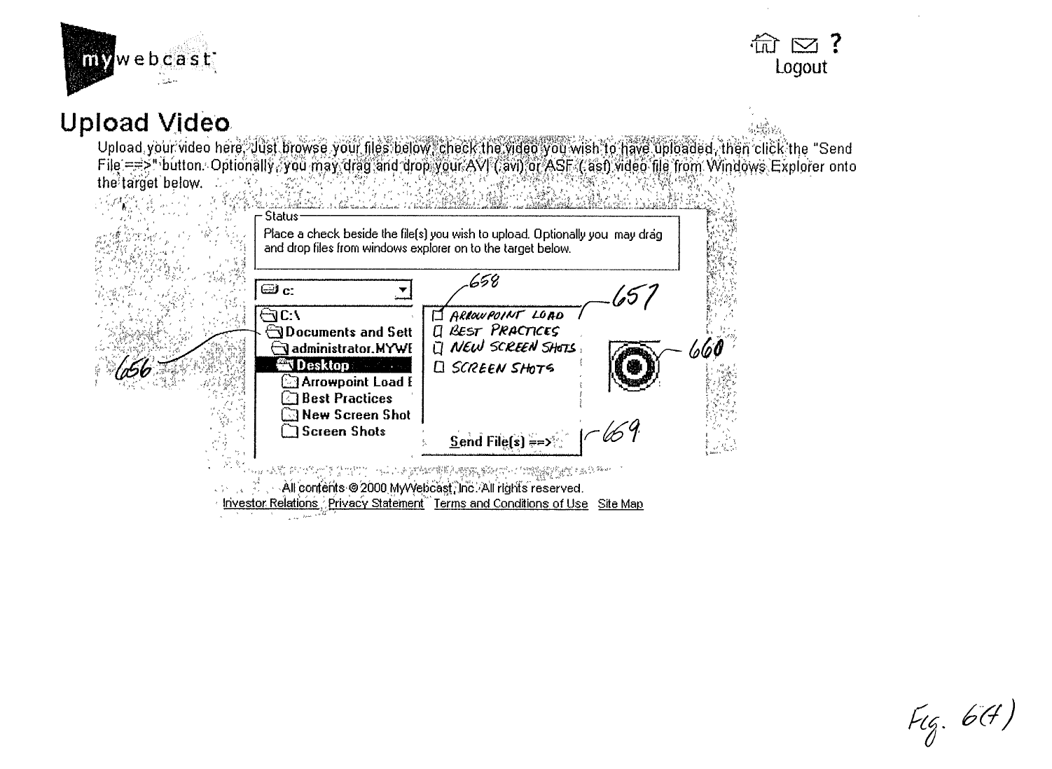

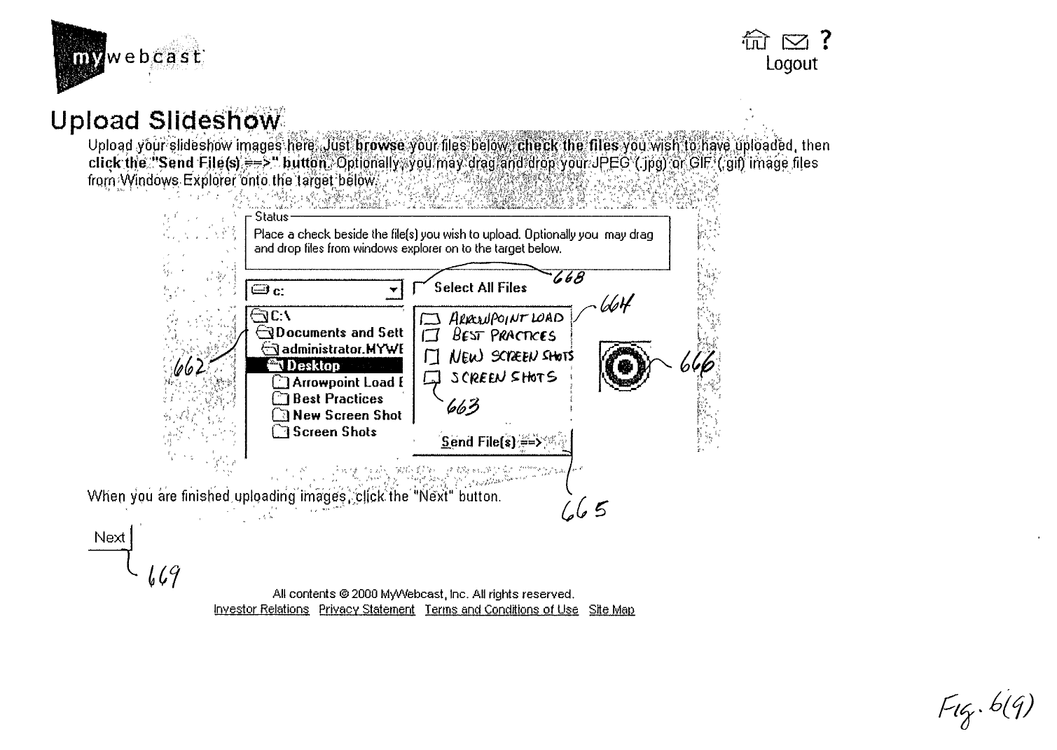

The creation, transmission and viewing of a webcast presentation in the webcasting network 100 will now be described in greater detail with reference to FIGS. 3 and 4.

At step 140 in FIG. 3, the content used in the webcast presentation is recorded or captured by the user. For purposes of this particular example, it is assumed that the content would initially consist of video and slides (e.g., PowerPoint). However, as discussed elsewhere herein, other media content may be included in the presentation.. The user accesses the website at the webcast server 104 using a browser 141 (FIG. 4), logs in to the webcast server (step 144) and is then prompted for the existence of account information (steps 148, 156). If the user does not have an account, one is set up (step 152) and the pertinent account information is entered and then stored in the data server 116. While not illustrated in FIG. 3, the application server 114 may have a credit card processing function 149 (FIG. 4) for verifying the availability of credit during account set up and for later billing the cost of the webcasting transaction to the user.

If the user simply wants to edit his account (step 160), the application server permits him to so by using an Account Control feature 161. Editing would include, for example, deleting previous webcasts that the user no longer wants accessed by viewers, notifying additional recipients of existing webcasts, monitoring webcast viewing (number, identity of viewers), and accessing an existing webcast to update its content.

Once an account has been set up (or if an account already exists), the user is asked if a new webcast is to be created (step 162). As part of creating a new webcast, the user is asked (step 166) if he has content (video, slides, etc.), and if not, is prompted to leave the system and return when the content of the webcast has been recorded and stored in the users system (step 140).

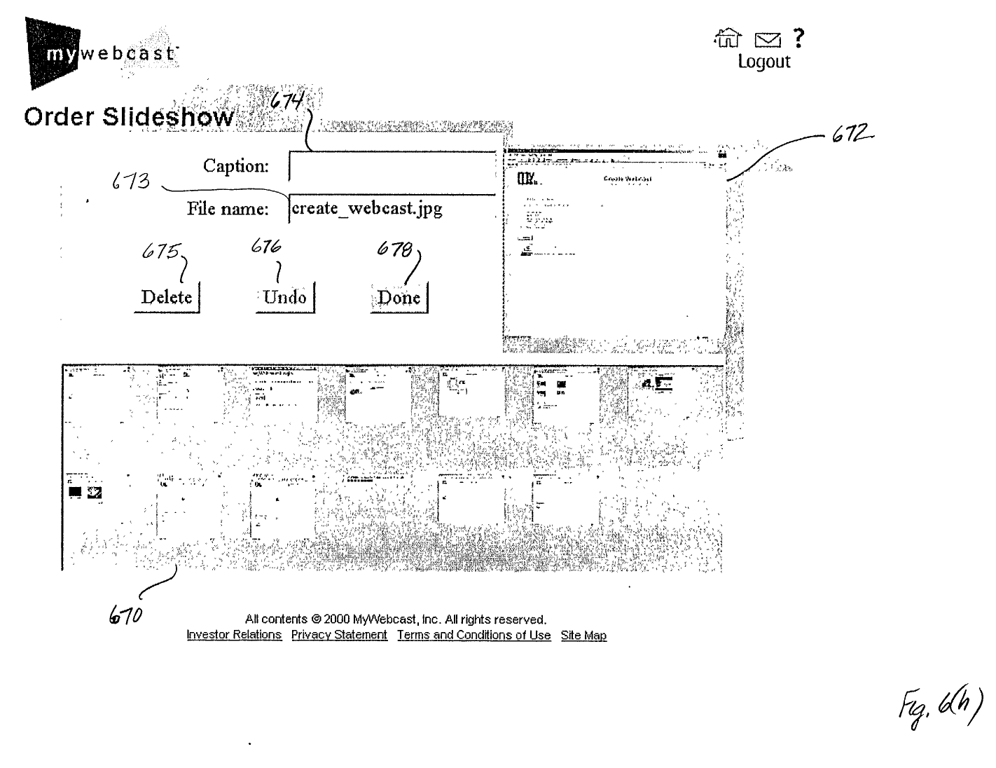

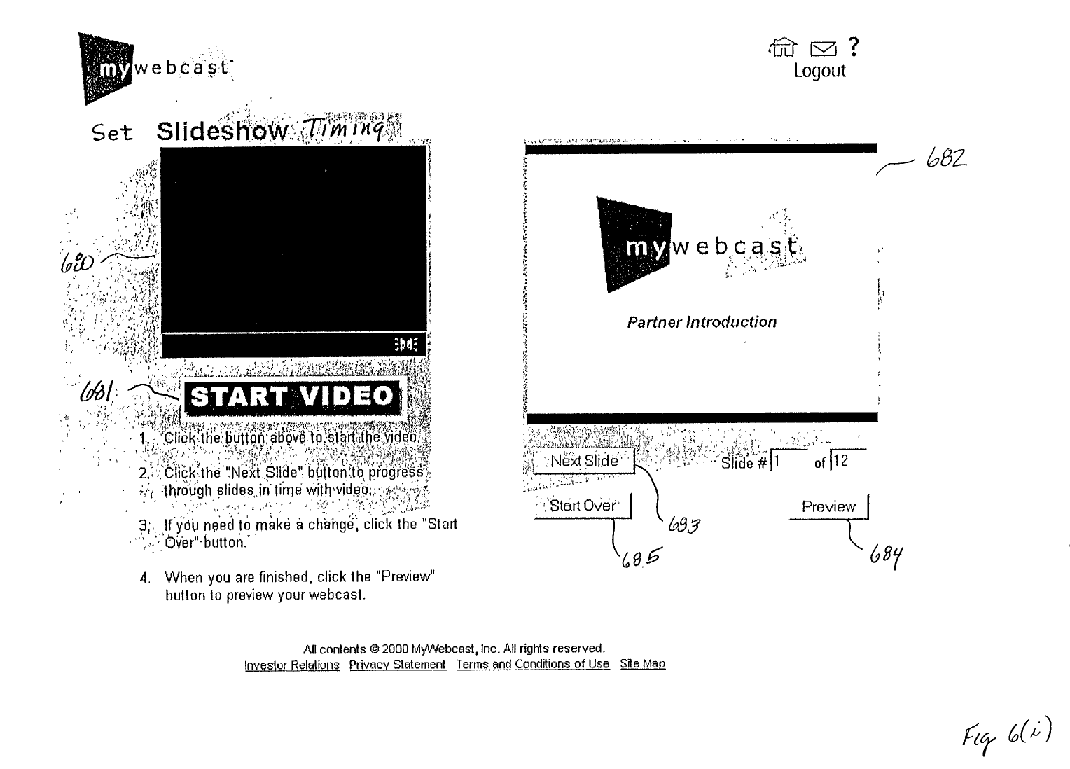

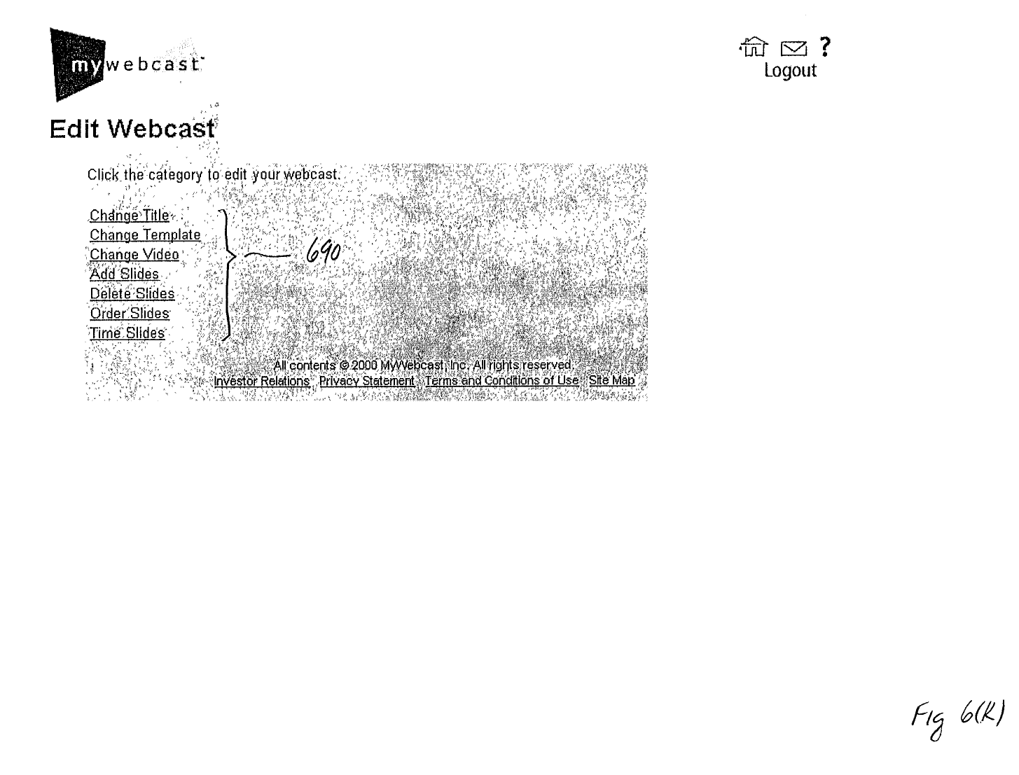

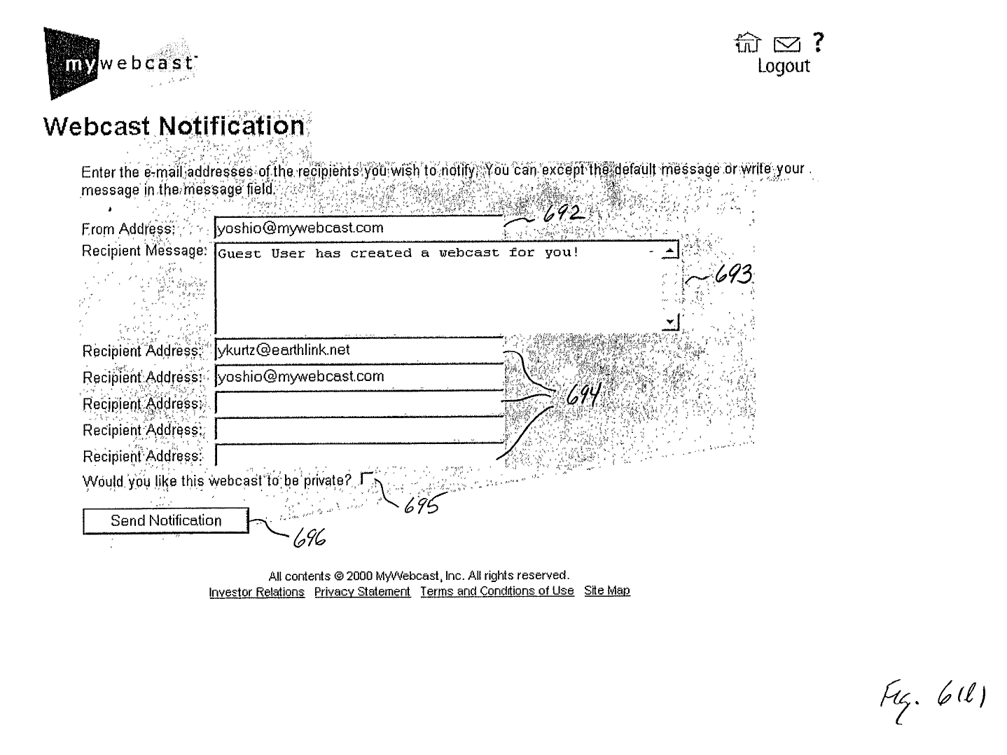

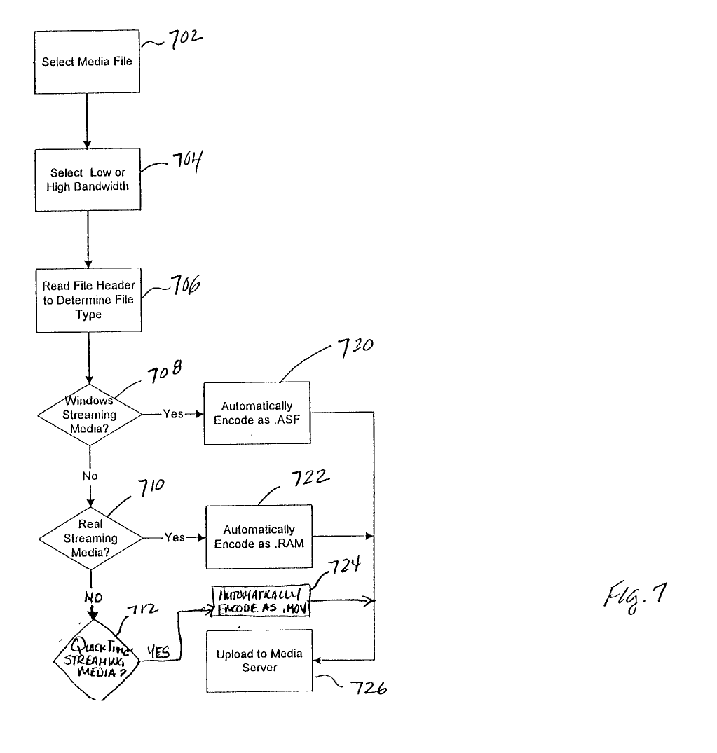

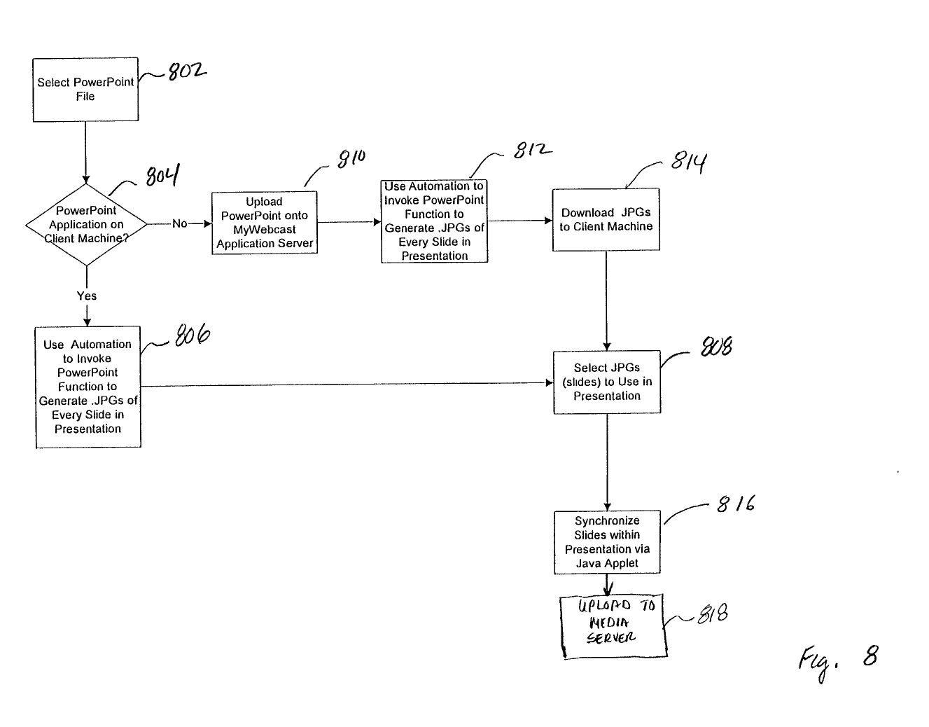

Content can be from any one of many conventional sources, such as a digital camera, camcorder, audio recorder, CD , DVD, etc. Once it has been created, it is loaded (captured) in the system 102 (step 168) as a file, and then encoded (compressed) at step 172. The encoding of the content is accomplished by an Encode DLL (dynamic link library) application 176 in the system 102 (see FIG. 4), the application 176 having been downloaded into the users system from the application server 114. The encoding of video is done automatically without the user needing to understand the format of the video files stored, and will be described in greater detail later in conjunction with FIG. 7. The user executes a drag and drop application 180 (see FIG. 4 and the screens in FIGS. 6(f) and 6(g)), which not only initiates the encoding of the video file, but also initiates the uploading of the video and slide presentation files (step 182) by executing an Upload DLL applet 186.

The user then selects a presentation template, carried out by prompts from a template selection feature 188 in the application server 114 (see FIG. 4), to be more fully described later in conjunction with FIG. 6(e).

If the user has slides as part of the presentation (step 190), the timing and synchronization of those slides to the video is established at step 194. That synchronization information is also uploaded to the data server 116 by returning to step 182.

After the synchronization of the slides and video, the user is prompted to preview the webcast (steps 196 and 198). After previewing, the user is prompted to edit the webcast (steps 202 and 204), e.g., in order to change or adjust the synchronization of the slides and the video. The completed webcast presentation is then stored at the media server 112 (step 210).

The user may then notify potential viewers of the webcast (step 212), either by entering individual email addresses of the recipients or copying addresses from an email address book 220 in the user system. Those addresses are uploaded to an address book 222 at the email server 118, and are then used by a conventional email program 224 to generate and send email messages from the mail server 118 to potential viewers.

Individuals receiving the email notifications at their viewer systems 106 have an internet browser 230 (and a media player 232, to be described below), enabling them to view the webcast at steps 234 and 236, by executing a link in the email to begin the downloading (slides) and streaming (video) of the presentation to the viewer (step 228).

Additional features in the webcasting network 100 are also illustrated in FIG. 4. For example, the media server system 112 (which, for ease of illustrating interconnections, is shown separately on the left hand side of FIG. 4, even though it is functionally part of the webcast server 104), can consist of several separate media servers 112-1, 112-2 and 112-3. This is done so that each viewer can have the presentation displayed on his or her viewer system 106 using, as the media player 232, any one of several widely available media players (e.g., Microsoft Windows, Real Networks or Apple QuickTime players) that the viewer may have previously installed. Thus, the individual media servers 112-1, 112-2 and 112-3 could be a Windows media server, a Real Networks media server, and an Apple QuickTime media server, respectively (of course, any other media server that currently exists or is hereinafter developed, may also be used). The user (the producer of the webcast) would preferably store (after being encoded) a copy of the presentation in each media server, so that viewers having any one of the matching players (i.e., Windows, Real Network or Apple QuickTime) could view the presentation.

During set-up of the presentation at the viewer system 106, a chat applet 242 may be downloaded by the application server 114, so that the viewer may participate in “live” chat with other viewers (or the presenter) during the presentation. The chat could be coordinated by a conventional chat server subsystem 246 within the application server 114.

During set-up prior to creation of the webcast presentation, the user system 102 could have any one of several commercially available media software development kits (SDK) 250 installed on the user system in order to assist in the encoding of files for transmission over the internet, as well as to edit the content and to add markers and script commands to synchronize the presentation and arrange it properly on the viewer's screen. In the illustrated embodiment, where the media server 112 consists of a Windows media server, a Real Networks media server, and an Apple QuickTime media server, an SDK for each of those servers would be needed.

If desired, pay-per-view functionality 252 could be loaded into the user system. This enables the webcast presentation to initially present a prompting screen (see FIG. 6(c)—to be described later) to the viewer to enter credit card information, which is uploaded to the application server 114. The viewer is permitted to begin the transmission of the webcast presentation to the viewer's system 106, but only if a credit card charge is agreed to. This functionality would be useful, for example, to a commercial training organization that is using the webcast to offer fee-based training or seminars.

Also, an optional “order CDs” prompt (see FIG. 6(a)—to be more fully described later) may be displayed to the viewer, enabling the viewer to order copies of the presentation on CD (compact disc). The ordering information may be provided to the application server 114 in order to initiate the order for a CD. This feature might be useful to a consumer using the webcasting network 100 to send personal videos to friends or family, and wanting to make sure copies are made available for future viewing.

An audio-to-text feature may also be implemented within the application server 114. This would permit the viewer to receive a transcript of the presentation, e.g., in lieu of seeing the presentation itself. This could be accomplished as part of the initial email notification to the viewer. In addition to providing a link to a website for viewing the presentation, the initial email notification could include a link to a page or document within the website that permits the potential viewer to request a transcript. Alternatively, the webcast itself could have a prompt (see FIG. 6(a)—to be described later) for requesting the transcript. The viewer could ask for the transcript to be emailed to a specific email address or to a specific display device (e.g., a personal digital assistant) where the text can be read at the convenience of the viewer, independently of the webcast presentation. The text of the transcript may stored as a data block 262 in the data server 116, and can either be stored at block 262 in response to a previously created transcript provided by the user during webcast creation, or be automatically generated using a conventional voice recognition program (not shown) in the application server 114, after the presentation has been finalized and stored in the media server 112.

A conventional bulletin board function 266 in the application server 114 enables the server 114 to maintain a bulletin or message board (not shown) for each presentation. The viewer could be provided a link to the board as part of the presentation and can post messages concerning the presentation, or read messages posted by others.

Also in the application server 114, a teleconference function 268 permits live audio conversations at designated times during the presentation. At those times, a screen (see FIG. 5(b)—to be described below) would appear in the presentation informing viewers that the conversations can take place, resulting in session somewhat similar to a live “telephone” conference call. An example of a use of this feature would be in a webcast presentation of a seminar topic, where viewers need the opportunity, at certain points during the seminar, to engage in an interactive question and answer session with the presenter. The voice conversations among the participants could be carried over the internet using conventional “voice over IP” application programs (not shown). Importantly, those voice conversations can be stored at webcast server 104 as part of the webcast presentation. Thus, if a viewer misses the initial webcast program, the entire program (including video, slides and voice discussions) can be later downloaded by that viewer.

Finally (as to FIG. 4), there is a Resize JPEGS function 270 in the application server 114 for creating “thumbnail” images of the slide presentation. This permits the slide images to be presented to the user (webcast creator) as a group of slides on a single screen, so that they can be viewed together and easily re-arranged during the creation of the webcast (as will be more fully described in connection with FIG. 6(h)).

Referring now to FIG. 5(a), there is illustrated an screen 500 representing one exemplary view in a webcast presentation created in accordance with the present invention. The screen 500 is viewed at the viewer system 106 and, as described earlier, includes a frame or window 502 for a video presentation, a frame 503 for a slide presentation, and frame 504 for a “live chat” session. As described in connection with FIG. 1, in one embodiment the webcast could be a sales presentation, with the video presentation 502 being a “live” or taped video program (where the presenter is a sales person). Immediately below the video frame are control buttons 504, 506, and 508, which permit the webcast to be paused, played or stopped, respectively. The elapsed playing time as well as the total length or duration of the webcast are shown at 510 (in the illustrated screen, the presentation is at “82:23/87:15”—i.e., 82 minutes and 23 seconds into a total presentation time of 87 minutes and 15 seconds). The title or topic of the presentation is shown below each of the video and live chat frames at locations 512 and 513, and also immediately above the slide presentation at a location 520. The name of the presenter appearing in the video frame is shown at 522. As illustrated, one or more additional frames 524 could be used for promotional or advertising links.

As mentioned in connection with FIG. 2, the slide presentation 503 consists of slides illustrating the points being made by the sales person or presenter (in FIG. 6(a), a sales “pie chart” with appropriate explanations). The chat frame 504 contains a transcript of comments entered by viewers as they see the presentation.

As earlier described, the viewer of the presentation can order a CD copy of the presentation and/or an written transcript of the audio portion of the presentation. This is accomplished by the screen buttons 532 and 534 which provide HTML links to websites that permit orders to be taken using well know and standard order screen formats and processes. In FIG. 6(a), the buttons 532 and 534 are shown at a point in time well into the presentation, but it should be apparent that they could be displayed at anytime before, during or after the presentation.

In FIG. 5(b) there is illustrated a screen 540 that would be seen by viewers for initiating a “live” discussion session, described earlier in conjunction with FIG. 4. The screen 504 could appear at any time during the webcast presentation.

In FIG. 5(c), there is shown a screen 550 that may be used for a “pay-per-view” presentation, also described earlier in conjunction with FIG. 4. The screen 550 indicates the charge for viewing the webcast and has fields 552 and 554 for the viewer to enter credit card information. After entry of credit card information, a submit button 556 is clicked, and the webcast begins.

Referring now to FIGS. 6(a) through 6(l), there are shown screens or pages which include html links, drop-down menus, drag-and-drop icons and other web-based features and technologies presented to the user (the person creating the webcast) in order to create and transmit a webcast over the webcasting network 100. These screens will now be described in the same general order as they would be seen by the user at system 102.

FIG. 6(a) represents a view of a home page 600, where the user can gain access to the webcast server 104. Links provided at the upper right hand comer and at the bottom of the home page may also appear on other pages presented to the user, in order to provide a consistent navigation scheme that is readily recognized by the user. Such html links may include: (1) a home link 602 for immediate navigation to the home page of FIG. 6(a) from any other screen or page; (2) an email help link 604 for navigating to a page having an email template for requesting on-line technical assistance; (3) a FAQ link 606 for navigating to a page having FAQs (frequently asked questions) on the use of the webcasting service; (4) an “Investor Relations” link 610 for obtaining information of interest to potential shareholders or investors; (5) a “Privacy Statement” link 612; (6) a “Terms and Conditions of Use” link 614; and (8) a “Site Map” link 616.

On the right-hand side of the screen in FIG. 6(a) are further links providing access to other information, including (1) an “About Us” link 620 for providing general information about the company providing the webcasting service, (2) a “View Demo” link 621 for providing access to a demonstration of a webcasting program, (3) a “Partners & Clients” link 623 for company information of interest to potential marketing partners and customers, and (4) a “Contact Us” link 624 for phone number, address and other contact information pertaining to the webcast service provider. If the user has already established an account, fields 625 and 626 are provided for a user name and password. After entry of the user name and password, the user may click a Submit button 627, for immediate access to a Main Account page, to be described below.

At the top of the home page in FIG. 6(a) are (1) a “Sign In” link 630 which takes the user to a screen (not shown, but redundant to the fields 625, 626 and button 627), for entry of a user name and password and subsequent access to the Main Account page, (2) a “New User Registration” link 631 for setting up a new account (presenting a screen for entry of basic user information in order to establish a new account), (3) a “Products and Services” link 632 for providing information on all the products and services offered by the webcast service provider, and (4) a “Free Trial Offer” link 633 for providing complimentary use of the webcasting service. A second (redundant) “Free Trial Offer” link 634 is also provided on the right-hand side of the screen, as well a second (redundant) new user registration or “Sign Up” link 635.

The “Account Main” page is seen in FIG. 6(b). This page is accessed if the user has an established account. At this page, the user may click on the “Create Mywebcast” link 636 in order to start the creation of a webcast program, or may click on various “Account Options” links—an “Edit Portfolio” link 637, an “Edit Account” link 638 and an “Account Status” link 639. These “Account Options” have been described earlier. Briefly, the Edit Portfolio link 637 provides a screen or page (not shown) that permits the user to edit or delete existing webcasts, notify additional webcast recipients, and monitor usage (number of viewers) of existing webcasts. The “Edit Account” link 638 permits the user to edit account information, such as billing address, user names and passwords. The “Account Status” link 639 permits the user to review account information, such as billing cycles and billing statement charges.

Also seen in FIG. 6(b) is a “Logout” link 640, which similarly appears on subsequent screens at the user system. By clicking on the Logout link 640, the user may immediately leave the webcasting system.

If the “Create Mywebcast” link 636 is selected in FIG. 6(b), then the screen in FIG. 6(c) appears. The purpose of the screen in FIG. 6(c) is to initiate the installation of various programs and applets at the user system 102 in order to create a webcast presentation. In particular, the following applications (earlier referenced in connection with FIG. 4) are downloaded from the application server 114 to the user system 102: (1) Encode DLL 176, (2) Upload DLL 186, (3) Drag & Drop application 180, and (4) Pay-Per-View functionality 252. At the same time, if the user does not already have the appropriate SDK 250 (FIG. 4), he or she is prompted to download those applications from the appropriate vendor (Microsoft, Real Networks, Apple). Once the programs and applets are downloaded and installed in “Step 1” of FIG. 6(c), the user goes to “Step 2” and clicks the “Continue” button 642.

At the next screen in FIG. 6(d), the creation of the webcast begins with the user entering the title of the webcast program in the title field 644. This screen also identifies the seven general steps (displayed in the forms of html links 645) that the user will go through in creating the webcast. If the user wants to advance out of order to one of these steps (e.g., if the user has previously completed some steps, but not others), the appropriate one of the links 645 is selected. Otherwise, the user clicks on the “Continue” button 646.

At the next screen in FIG. 6(e), the user picks the templates that will be used in creating the appearance or format of the webcast screens. In the exemplary embodiment, the user makes selections at a “Select Category” drop-down menu 647, a “Select Theme” menu 648, and a “Select Template” menu 650. An example of the resulting webcast screen, based on the selections made, is displayed at a “Preview” window 652. The various choices given to the user in each of the drop-down menus in FIG. 6(e) will, obviously, depend on design decisions made by the webcasting service provider, and are not critical to the present invention. However, the following three tables illustrate exemplary choices (and the resulting appearance or format) for each of the drop down menus.

TABLE I
(Category)
Business (video and slide frames)
Personal (video only)

TABLE II
(Theme)
Sales (video and slides in sales format)
Presentation (video and slides in an intra-company format)
Education (video, slides, live discussion sessions)

TABLE III
(Templates)

Metal Light
Metal Blue
Lines Blue
Lines Gray
The choices in Table III define screen background and color.

In FIG. 6(e) there are additional illustrated options that may be chosen, such as:

(1) “Video Source” (i.e., a existing video file or a “live” streamed video)

(2) “Video Format” (the media players for which the presentation will be prepared—e.g., Windows, Real Player, Apple QuickTime)

(3) “Live Chat” or “Discussion Board” (i.e., does the user want the viewers to have a frame or window for conducting live chat discussions during the presentation, or merely a link to a message board for posting or reading messages concerning the presentation)

(4) “Display Your Company Logo” (e.g., displaying the user's logo at a predesignated position on the webcast screen)

(5) “Notify Me When Someone Views” (e.g., an email notification will be sent to the user when someone views the webcast)

(6) “Optimize Viewing” (the user selects whether the webcast will be encoded for a viewer having either a low bandwidth connection to the internet, e.g., 56K dial up modem service, or a high bandwidth connection, e.g., DSL, cable modem service, etc.). While not illustrated in FIG. 6(e) or elsewhere, if the viewer will receive the webcast at a wireless device, such an option could also be provided (requiring that the webcast be encoded in a format suitable for wireless transmission).

After making the selections in FIG. 6(e), the user clicks the “Continue” button 654.

At the next screen in FIG. 6(f), the user initiates the uploading of the video to the server. As mentioned earlier, this steps includes both the encoding of the video file at the user's system (in order to efficiently transmit and store the video at the media server 112), as well as the actual uploading of the video from the user system 102 to the media server 112. Furthermore, as will be more fully described later in conjunction with FIG. 7, the user only needs to select the video file, with the Encode DLL 176 and Upload DLL 186 (FIG. 4) determining the type of file encoding needed and completing that encoding (and uploading) without further intervention by the user.

In FIG. 6(f), the user selects the video file by either:

(1) opening a file folder in the drop down menu 656, which causes the files in that folder to be displayed in a checkbox window 657. A check is put in a checkbox 658 next to the file to be selected, and the user clicks the “Send File(s)” button 659, or

(2) selecting the file in drop down menu 565 and then “dragging and dropping” it on the target icon 660.

The next screen in FIG. 6(g) appears and the user performs a similar selection of the slide presentation (slideshow) files for encoding and uploading (either using the drop down menu 662, checking a checkbox 663 in window 664, and clicking the “Send Files” button 665—or alternatively, dragging and dropping the file onto the target 666). In FIG. 6(g), a “Select All Files” checkbox 668 may be used to select all the slide files displayed in window 664. After completing the selection of the slide files, the user clicks on the “Next” button 669.

At the next screen in FIG. 6(h), the user selects the order of the slides in the webcast. Thumbnail images of all the slides in the selected file are seen in a lower frame or window 670, and each image (when selected) is enlarged and displayed in a side window 672. The file name of the displayed image or slide (in window 672) is shown in a File Name field 673, and the user may enter a caption or title for that slide in a Caption field 674. The order of the slides may be changed by dragging the slide image to the desired location within window 670. Selected slides may be deleted by using the “Delete” button 675. Any deletions may be undone by using an “Undoε button” 676, and once the order of the slides is acceptable, the user clicks a “Done” button 678 to move to the next screen.

While in the described embodiment the slide presentation is created as a PowerPoint file, it should be apparent that other presentation, CAD or drawing software applications could be used as well (e.g., Visio, CorelDraw).

At the next screen in FIG. 6(i), the user selects the timing (synchronization) of the slides relative to the video presentation. The video presentation begins to play and is displayed at a video window 680 when user clicks a “Start Video” button 681. At the same time, the first slide (Slide “#1”)is displayed in a slide window 682. As the video plays, the user clicks a “Next Slide” button 683 when the next slide (Slide “#2”) is to appear in the webcast, and that slide then appears in the slide window 682. The timing of subsequent slides in accomplished in the same manner until all slides have been inserted. The user then clicks a “Preview” button 684, in order to see the entire webcast presentation, including the timing of each slide to the video. At any time, if the user wants to redo the timing, the process is brought back to the beginning and can be redone by clicking the “Start Over” button 685. If the “Start Over” button 685 is not clicked, the timing is finished and the next screen appears.

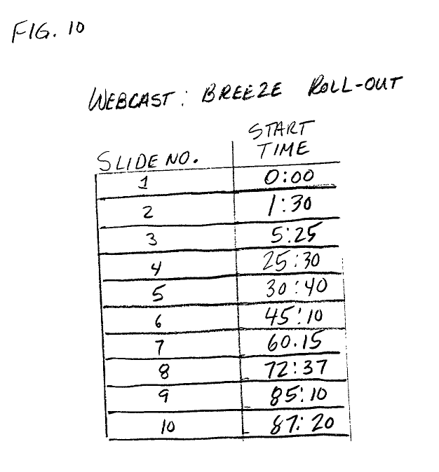

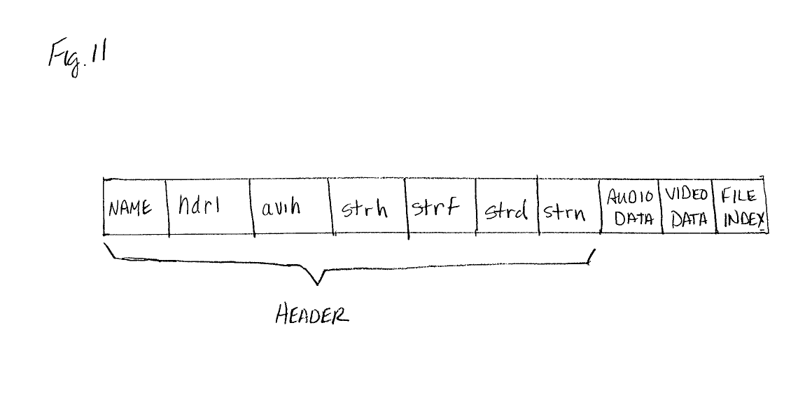

Before proceeding to the next screen, reference is made to FIG. 10 which shows (in exemplary form) data representing the timing (synchronization) of the slides to the video. The timing data is generated in response to the inputs at the screen in FIG. 6(i), and is stored in the data server 116. The timing data identifies for each slide the particular point in time during the video program that the slide is to be displayed (e.g., at the window 503 in FIG. 5(a)). Thus, in FIG. 10, for the exemplary webcast program identified as “Webcast: Breeze Roll-out”, there are ten slides (Slides 1 through 10), and for each slide there is shown the start time for that slide. As illustrated in FIG. 10, Slide #1 starts at 0:00 (at zero minutes and zero seconds, i.e., at the start of the program); Slide # 2 starts at 1:30 (one minute and thirty seconds, which also represents the end of the preceding slide); and so forth through all the slides. Note that in the view of the webcast program shown in FIG. 5(a), the program is at 82:23. At that particular time, and assuming that the timing data in FIG. 10 is used, Slide # 8 would be displayed. While not shown, there could be provided in an alternative embodiment a stop time for each slide (which would permit the absence of slides at certain points during the video presentation).

In the next screen (FIG. 6(j), the user is previews the entire webcast as it will appear at the viewer system 106. At the top of the screen is an “Edit Webcast” button 687 for editing the webcast, a “Save Webcast” button 688 if the webcast is acceptable (it will then be stored as an available webcast in the media server 112), and a “Start Over” button 689 if the user wants to preview the webcast again.

If the “Edit Webcast” button 687 is clicked, the screen in FIG. 6(k) appears. The user may click on any one of the links 690 (“Change Title”, “Change Template”, Change Video”, “Add Slides”, “Delete Slides”, “Order Slides”, and “Time Slides”) in order to return to the appropriate screen and effect the desired editing.

As the last step in the creation of the webcast, the user may provide notification to intended webcast recipients. This is accomplished by the screen in FIG. 6(l). The screen can be made to appear immediately after the webcast is saved (FIG. 6(j), or can be reached through the Edit Portfolio link 637 seen in FIG. 6(b). The screen in FIG. 6(l) includes a field 692 for the user (webcast creator) email address, a window 693 for inserting a message, and fields 694 for recipient email addresses. Also, the user may mark a checkbox 695 to designate the webcast as private (e.g., requiring the viewer to use his approved email address or a password in order to receive the webcast). As mentioned earlier, the email notification will include a link to a website for viewing the webcast. When the user is ready to send the email notification to the recipients, a “Send Notification” button 696 is clicked.

Referring to FIG. 7, the process by which a video presentation is automatically encoded (compressed) and uploaded to the media server 112 is illustrated. As mentioned earlier, the encoding can be done without the webcast creator having any understanding of the file formats of the original video capture or the manner in which the encoding to the new format needs to be done. In addition, desktop systems many times do not display file extensions when a user accesses files (or those file extensions are ambiguous), and thus the typical desktop user (especially a consumer or small business owner) will not know the file extension (and hence, not know the format of a file) without having sophisticated knowledge of the system or desktop being used. The present webcasting system and method eliminates the need for the user to have such knowledge.

Initially, the user selects (step 702) the media file (video file) that needs to be encoded. As mentioned earlier, files may selected during webcast creation with a “drag & drop” or similar feature (see the screens in FIGS. 6(f)) and, after selecting the file, the process in FIG. 7 is transparent to the user.

After the video file has been selected, the user system 102 then determines (from the data entered by the user at the screen in FIG. 6(e)) whether the transmission to viewers will be over a “low” or “high” bandwidth connection, step 704. As mentioned earlier, if the viewers have DSL (digital subscriber line) or cable modem service, the media file is encoded for high speed transmission. If the viewers have a dial-up modem connection, the media file is encoded for low speed transmission.. The system then reads the file header (step 706) to establish the file type (e.g., .avi, .mov, MPEG) to be converted.

This last mentioned step is more fully understood by briefly referring to FIG. 11, which shows the conventional and well known file format or structure of a file having an .avi format. As can be seen, the header of that file includes a “Name” of “File Type” field (which will include the characters “avi”). The other fields are not important for purposes of the present discussion, but they include header fields “hdrl” (defines format of the data in the file), “avih” (general information, such as number of streams), “strh” (type of stream, i.e., video, audio, etc.), “strf” (BITMAPINFO structure), “strd” (compression and decompression information) and “stm” (name of the data stream), and the non-header fields “audio data”, “video data” and “file index”.

In accordance with the present invention, the Encode DLL 176 (FIG. 4) is programmed to look (in the conventional and predesignated location of the file format) for the data in the “Name Field” of the video file and if it finds the characters “avi”, it determines that the file in question is an avi file. Similarly, other common video file formats (.mov, .ram, MPEG) have analogous header information (a Name or File Type field) identifying the file type or format. If the file is not an avi file, then the encode DLL 176 is programmed to sequentially look for the name field representing other common video file formats (e.g. first looking for the name field in .mov format, if not there, looking for the name filed in .ram format, and if not there, looking for the name field in MPEG format), and by a process of elimination, ultimately is able to determine the file format (e.g., whether it is an .avi, .mov, .ram or MPEG file). While in the present embodiment the encode DLL 176 is designed to look only for the common file formats mentioned, it should be apparent that it could be easily designed to look for other conventional file formats as well.

It should be appreciated that the determination of the file type at step 706 could be accomplished in many instances by the user system simply looking at the file extension. However, as noted earlier, sometimes file extensions are not displayed when a file is accessed. In other instances the file extension could be ambiguous or unclear as to the application on which it will run. If that should be the case, an extra step may be needed—e.g., if there was no file extension to be read by the user system, the user would need to be prompted to open or manipulate the file in a way to reveal the file extension, and then manually enter that information into the system. Obviously, the automatic feature of the present invention as illustrated in FIG. 7, i.e., the reading of the file header to determine the file type, is preferable since it would eliminate the need for such an extra step.

After the file type is determined, the system determines (from information entered at the screen in FIG. 6(e)) what streaming media will be used at steps 708, 710, 712 (i.e., will the presentation be encoded for viewer systems having a Windows media player, a Real Networks media player, or Apple QuickTime media player?). At steps 720, 722 and 724, if the presentation will be encoded for a Windows media player, then the file is converted to an .asf format; if encoded for a Real Networks media player, then to a .ram format; and if encoded for a QuickTime media player, then to a .mov format. It is assumed for purposed of FIG. 7 that the video will be encoded for only one type of media player, although it should be appreciated that, within the scope of the present invention, one could produce a webcast program for each type of player. Once encoded, the file is then uploaded and stored in the appropriate media server 112-1, 112-2, and 112-3 (FIG. 4).

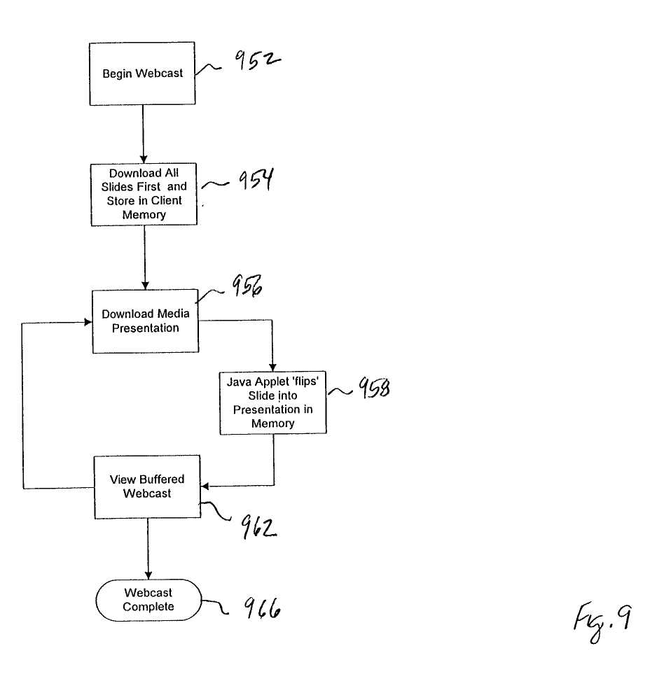

Referring to FIG. 8, the process (in flow diagram form) by which the slide presentation is converted from a structured storage file (e.g., from PowerPoint file) to an image-based file (e.g., JPG), and then uploaded to the media server 112, is illustrated. Although the process of FIG. 8 is illustrated as a file conversion from PowerPoint files to JPG files, it should apparent to those skilled in the art that the process is applicable to converting other large, structured storage files (e.g., MS Word, Excel, Lotus, WordPerfect) to image-based file formats, such as JPG. Before describing the individual steps in the process illustrated in FIG. 8, it is worth noting that the conversion of the files to JPG format provides considerable advantage in transmitting those files to viewer systems 106 and in synchronizing the individual slides to the video presentation. In particular, files stored in PowerPoint or other structured storage format (having both header fields and content fields) are typically large, and thus require considerable time to transmit over the internet. On the other hand, files in JPG format are considerably smaller and thus can be transmitted much more quickly and efficiently. In addition, as well known to those skilled in the art, PowerPoint files are much more difficult to manipulate (i.e., manipulate as individual slides) because all slides are looked on as a single PowerPoint file and need to be dealt with as such. This makes the ordering of JPG files, and their synchronization with the webcast video presentation) much more desirable than PowerPoint files.

In FIG. 8, the PowerPoint file to be used in the webcast presentation is first selected at step 802 (this is done with use of the screen in FIG. 6(g)). If there is a PowerPoint application on the client or user system 102 (step 804), then a conventional automation method (well known to those skilled in the art) is used to invoke the image handling and JPG conversion object files resident in PowerPoint application programs. This may be done without “running ” or executing the PowerPoint application program on the user system. Instead, code in the Encode DLL 176 will call the JPG conversion object file directly, without going through the PowerPoint application. The JPG object files are then used to convert the slides in the PowerPoint file into individual JPG image files (step 806). As one example of invoking the functionality in the PowerPoint application to convert PowerPoint to JPG, the following subroutine could be used:

Dim PowerPointApp=CreateObject(“PowerPoint.Application”)

PowerPointApp.SaveAs Filename:=“Filename.ppt”,

FileFormat:=ppSaveAsJPG, EmbedTrueTypeFonts:=msoFalse

In this example, the subroutine creates a PowerPoint object (a “hidden” version of the PowerPoint application). The PowerPoint object has a “save as” property, which invokes the functionality to save the PowerPoint file as a specified file type format. The specified file format in this case is JPG, as indicated by the variable ppSaveAsJPG in the functional call of the subroutine. This functional call invokes the functionality contained in the PowerPoint application with the parameters specified.

The JPG images are then presented to the user so that they can be selected and ordered (see the screen in FIG. 6(h)) at step 808.

If there is not a PowerPoint application program on the user system 102, then the selected PowerPoint file is uploaded (step 810) to the application server 114, where the image handling and JPG conversion objects are invoked (step 812), and the resulting JPG files downloaded back to the client or user system 102. Those files are then selected (step 808).

The individual slides (in JPG format) are synchronized (step 816) with the video presentation, using a Java applet that implements the features of the screen in FIG. 6(i) and that generates the timing data illustrated in FIG. 10.. Finally, the slide presentation (and timing data) is uploaded to the media server, step 818.

FIG. 9 illustrates the process by which the slide presentation is stored in the memory of the viewer system 106 in order to be synchronized with the video presentation. As mentioned earlier in conjunction with FIG. 2, storing the slides first in the memory of the viewer system provides significant advantages over simply streaming the video presentation with the slides already synchronized and incorporated as part of the video presentation.

When the webcast is begun (step 952) at the viewer (client) system 106, the media server 112 first downloads the slides (e.g., in a JPG format) and an HTML file into the viewer (client) system memory, step 954. The HTML file contains timing (synchronization) information for the slides (such as that previously described in conjunction with FIGS. 6(i) and 10). The video presentation is then downloaded (streamed) to the viewer system (step 956) and as the video is received by the media player, a Java applet (not shown) loaded into the browser during the set-up of the webcast at the viewer system 116 reads the timing information contained in the HTML file. That applet retrieves each slide (JPG file) from the memory of the viewer system at the time established in the timing data and inserts or “flips” the slide (step 958) into the video presentation (i.e., the point where the slide was put during synchronization as the webcast was being created) as the video is received at the viewer system. Recall from the description in connection with FIGS. 6(i) and 10 that timing of slides in relation to the video presentation is accomplished by creating a data table of timing information as illustrated in FIG. 10 and such data table is the information contained in the HTML file loaded into the viewer system 116.

The video is buffered for display during this process as it is streamed into the viewer system, and so the “flipping” of slides continues until all the video has been streamed, buffered, and viewed (steps 956, 958, 962). The webcast presentation is then completed, step 966.

In conclusion, the present invention provides a novel method and system for creating and transmitting a webcast presentation. The invention enables a webcast presentation to be easily and quickly created and modified without sophisticated understanding of the data files (and their formats) used in the webcast presentation. While a detailed description of exemplary embodiments have been given above, various alternatives, modifications, and equivalents will be apparent to those skilled in the art without varying from the spirit of the invention. Therefore, the above description should not be taken as limiting the scope of the invention, which is defined by the appended claims.

What is claimed is

1. In a computer network for transmitting a multimedia program to one or more program recipients, the network including a server system and a recipient system, wherein the multimedia program includes a first media program and a second media program, the first media program having plural program components that are synchronized with the second media program so that each component appears at predetermined times during the second media program, a method for transmitting the multimedia program to each recipient, comprising:
storing the first and second media programs at the server system;
transmitting the first media program and the second media program to the recipient system; and
synchronizing the first media program components with the second media program after the first media program has been received at the recipient system.

2. The method of claim 1, wherein the first media program is stored in a memory within the recipient system before transmission of the second media program, and wherein the first media program is synchronized with the second media program as the second media program is received at the recipient system.

3. The method of claim 2, wherein the first media program is a slide presentation having a plurality of slide views and wherein the second media program is a video presentation.

4. The method of claim 3, wherein the multimedia program further includes a third media program, and wherein the third media program is a chat presentation in which any recipient may enter comments that are displayed to all recipients.

5. The method of claim 4, wherein the multimedia program further includes a fourth media program, and wherein the fourth media program is a live discussion session during which voice conversations between the recipients is transmitted using internet protocol.

6. The method of claim 3, further comprising:
providing a written transcript of the video presentation; and
at the request of a recipient, providing the written transcript to that recipient.

7. The method of claim 1, wherein the server system and the recipient system are interconnected by the internet.

8. The method if claim 7, wherein the network further includes a producer system connected to the server system by the internet, wherein the first and second media programs are transmitted from the producer system to the server system before being stored at the server system, and wherein the method further comprises encoding at least one of the first and second media programs before being transmitted to the server system.

9. The method of claim 8, wherein the first and second media programs are stored in the producer system before being transmitted to the server system, wherein the first and second programs are each stored in the producer system as a file having a specified file format, wherein the encoding of the at least one of the first and second media programs is based on the file format of the program to be encoded, and wherein the file format is determined from the file type field in the header of the stored file.

10. The method of claim 9, wherein the at least one of the first and second media programs to be encoded is a video program, and wherein the video program is stored as an .avi file in the producer system.

11. The method of claim 8, wherein the first and second media programs are stored in the producer system before being transmitted to the server system, wherein the at least one of the first and second media programs is a slide presentation stored as a structured data file format in the producer system, and wherein the structured data file is encoded into an image-base data file before being transmitted to the server system.

12. The method of claim 11, wherein slide presentation is converted to the image-based data file automatically by invoking image-based object modules associated with the structured data file.

13. The method of claim 12 wherein the structured data file is a PowerPoint file.

14. The method of claim 13, wherein the image-based data file is a JPG file.

15. A webcast system for downloading a webcast program to a viewer,
system, the webcast program including a video presentation, a slide presentation, and synchronization data, the slide presentation having multiple slide views that are synchronized with the video presentation in accordance with the synchronization data so that each slide view appears at a predetermined time during the video program, the system comprising:
a data server for storing the video presentation, the slide presentation, and the synchronization data;
an application server configured to transmit the slide presentation and synchronization data from the data sever to the viewer system before the video presentation is transmitted from the data server to the viewer system, so that the slide presentation is synchronized to the video presentation at the viewer system after the slide presentation has been transmitted to the viewer system.

16. A computer network for transmitting a multimedia program to one or more program recipients, wherein the multimedia program includes a first media program and a second media program, the first media program having plural program components that are synchronized with the second media program, the network comprising:
a server system for storing and transmitting the multimedia program; and
a recipient system for receiving the multimedia program from the server system;
the server system configured to transmit the first media program to the recipient system before the second media program so that to the first media program components are synchronized with the second media program after the first media program is received at the recipient system.

17. The network of claim 16, wherein the recipient system is configured to synchronize the first media program with the second media program as the second media program is received at the recipient system.

18. The network of claim 17, wherein the first media program is a slide presentation having a plurality of slide views and wherein the second media program is a video presentation.

19. The network of claim 18, wherein the multimedia program further includes a third media program, and wherein the third media program is a chat presentation in which any program recipient may enter comments that are displayed to all program recipients.

20. The network of claim 19, wherein the multimedia program further includes a fourth media program, and wherein the fourth media program is a live discussion session during which voice conversations among the program recipients is transmitted using internet protocol.

21. The network of claim 20, wherein the server system and the recipient system are interconnected by the internet.

22. The network of claim 21, further comprising a producer system connected to the server system by the internet, wherein the first and second media programs are transmitted from the producer system to the server system before being stored at the server system, and wherein the producer system encodes at least one of the first and second media programs before being transmitted to the server system.

23. The method of claim 22, wherein the producer system has a memory for storing the first and second media programs before being transmitted to the server system, wherein the first and second programs are stored in the producer system as a file having a specified file format, and wherein the producer system is configured to encode at least one of the first and second media programs based on the file format of the program to be encoded, and to determine file format from the file type field in the header of the stored file.

24. In a computer network for transmitting a multimedia program from a program producer to one or more program viewers, the network including a producer system, a server system and a viewer system, wherein the multimedia program includes a multi-view slide program and a video program, the slide program having multiple slide views that are synchronized with the video program so that individual slides appear at predetermined times during the video program, a method for transmitting the multimedia program to each viewer, comprising:
including in the slide presentation at least one view denoting a discussion period; and
during the discussion period, transmitting voice conversations between the viewers, the voice conversations transmitted using internet protocol.

25. The method of claim 24, wherein the voice conversations during the discussion period are stored at the server system so that the multimedia presentation, including the voice conversations, may be sent to a viewer after completion of the multi-media program.

26. A method for transmitting a multimedia presentation to recipients over the internet, each recipient having a display device for viewing the presentation and a speaker device for hearing the presentation, the method comprising:
providing a slide presentation to be seen on the display device;
providing a video presentation during which a presenter speaks, so that the presenter is seen by recipients on the display device and is heard by the recipients over the speaker device;
synchronizing the slide presentation to the video presentation;
providing a written transcript of the video presentation; and
at the request of recipients, displaying the written transcript on the display device.

27. In a computer network for transmitting a multimedia program from a program producer to one or more program recipients, the network including a producer system, a server system and a recipient system, wherein the multimedia program includes a multi-view slide program and a video program, wherein the slide program has multiple slide views that are synchronized with the video program so that individual slides appear at predetermined times during the video program, and wherein the slide program is initially stored as a structured data file at the producer system, a method for transmitting the multimedia program to each recipient, comprising:
converting the slide program from a structured data file to an image-based data file;
transmitting both the slide program, in the form of the image-based data file, and the video program to the server system; and
transmitting the slide program, as an image-based data file, and the video program from the server system to the recipient system.

28. The method of claim 27, wherein slide program is converted to the image-based data file automatically by invoking image-based object modules associated with the slide file.

29. The method of claim 28 wherein the structured data file is a PowerPoint file.

30. The method of claim 29, wherein the image-based data file is a JPG file.
